(19) United States
(12) Patent Application Publication
(10) Pub. No.: US 2015/0107629 A1
(43) Pub. Date: Apr. 23, 2015

(54) ENZYME-CONTAINING AUTOMATIC DISHWASHING BOOSTER/RINSE AID COMPOSITION, KIT CONTAINING THE SAME AND METHOD OF USING THE SAME

(71) Applicant: CHURCH & DWIGHT CO., INC., Princeton, NJ (US)

(72) Inventors: David S. Stott, II, Newtown, PA (US); Nicole Nguyen, Lawrenceville, NJ (US)

(73) Assignee: CHURCH & DWIGHT CO., INC., Princeton, NJ (US)

(21) Appl. No.: 14/059,848

(22) Filed: Oct. 22, 2013

(51) Int. Cl. C11D 3/386; A47L 15/42

(52) U.S. Cl. CPC C11D 3/386; A47L 15/4229
USPC 134/25.2; 510/514

(57) ABSTRACT

A booster/rinse aid composition for treatment of dishware prior to or after treatment with an automatic dishwashing composition, includes at least one surfactant, at least one anionic polymer, and at least one enzyme, wherein the composition is at least substantially free of alkaline builders, bleaches and bleach activators. A method of using the same and a kit is also described herein.

### FIELD OF THE INVENTION

The present invention relates to compositions for use in automatic dishwashing machines, and more particularly to an enzyme-containing booster/rinse aid composition.

### BACKGROUND OF THE INVENTION

Automatic dishwashing machines are mechanical devices designed to clean dishware and eating utensils in both institutional and household settings. The automatic dishwashing machines clean dishware using two or more cycles which typically include a wash cycle followed by a rinse cycle. Some machines are designed to provide soak, pre-wash, drying and/or additional wash cycles. During the main wash cycle, a dishwashing solution, comprising an automatic dishwashing composition (ADWC), typically containing alkaline salts, bleaches, bleach activators, anti-corrosion agents, builders, surfactants, etc., diluted or dissolved in water, is sprayed at the dishware and utensils to remove any food residues and debris deposited thereon. Once the wash is completed, the water is drained and the rinse cycle begins.

During the rinse cycle, hot water containing a rinse aid is sprayed at the cleaned dishware and utensils. The rinse cycle can vary from a few minutes to about 40 minutes. The temperature of the rinse solution typically ranges from about 40° C. to 60° C. The rinse aid contained in the rinse solution typically comprises non-ionic surfactants to promote a sheeting action that prevents droplet formation. This prevents spotting caused by droplets of water drying and leaving behind undissolved limescale minerals, while improving drying. After the rinse cycle is completed, hot air is passed over the dishware and utensils to initiate drying.

Many current automatic dishwashing compositions are now formulated with enzymes which significantly enhance the cleaning capacity of such compositions. Such enzymes break up and dissolve protein- or starch-based food deposits, and possibly oil, lipid and fat deposits. The enzymes constitute one of the more expensive components when provided in typical amounts effective for cleaning fully loaded, heavily soiled dishware and eating utensils. Thus, for loads that are lightly- to moderately-soiled or less than full capacity, the enzymes formulated in a preset dosage amount are largely wasted, and represent a significant cost to the consumer.

In addition, enzymes typically employed in automatic dishwashing compositions (ADWC) are to some extent incompatible with some of the other components of the composition, especially, for example, alkaline builders (e.g., metasilicates, alkali metal hydroxides, sodium carbonate), bleaches such as, for example, chlorine-based bleaches (e.g., sodium hypochlorite), and peroxide-based bleaches (e.g., alkali metal percarbonates), and bleach activators such as, for example, peracid precursors (e.g., triacetin, ethylene glycol diacetate and triethylacetyl citrate (TEAC)). Thus, the effectiveness of enzymes to remove food deposits becomes reduced by the presence of these components.

In recent years, there has been an emphasis on eliminating phosphates from ADWC. However, it is well known that, because phosphates are excellent for removing food deposits and residues, the elimination of phosphates has reduced cleaning efficiency when compared with phosphate-free AWDC. Efforts continue to obtain automatic dishwashing compositions which a) are phosphate free, b) achieve fully effective cleaning comparable to phosphate-based compositions, and c) are economical to use.

Accordingly, there is a need for an enzyme-containing automatic dishwashing booster/rinse aid composition that is formulated to alleviate the problems described above. There is a need for an enzyme-containing automatic dishwashing booster/rinse aid composition that enhances cleaning of dishware and eating utensils in an environmentally-friendly manner, while realizing cost savings to the consumer.

### SUMMARY OF THE INVENTION

The present invention relates to an enzyme-containing booster/rinse aid composition for treatment of dishware prior to or after treatment with an automatic dishwashing composition in an automatic dishwashing machine and method of using the same. The booster/rinse aid composition of the present invention generally comprises enzymes suitable for breaking down protein- and starch-based food residues and deposits, and is specifically formulated for use as a booster in a prewash cycle or as a rinse aid in a rinse cycle of a standard automatic dishwashing machine.

The booster/rinse aid composition of the present invention is utilized to improve the cleaning of the automatic dishwashing composition (i.e., enhancing both food residue and deposit removal performance and elimination of spotting and filming on dishware). In part, this is accomplished by providing enzymes in an environment where components which can adversely affect the efficiency of the enzymes are eliminated (e.g., alkaline builders, bleaches and bleach activators). The booster/rinse aid composition of the present invention also allows the consumer to adjust the amount of enzymes as needed based on degree of soiling and/or load size. The present invention offers the consumer greater flexibility and cost savings.

In one aspect of the present invention, there is provided a booster/rinse aid composition for treatment of dishware prior to or after treatment with an automatic dishwashing composition, which comprises:

at least one surfactant;

at least one anionic polymer; and

at least one enzyme;

wherein said composition is at least substantially free of alkaline builders, bleaches and bleach activators.

In a further aspect of the present invention, there is provided a booster/rinse aid composition for treatment of dishware prior to or after treatment with an automatic dishwashing composition, consisting essentially of:

at least one surfactant;

at least one anionic polymer; and

at least one enzyme;

wherein said composition is at least substantially free of alkaline builders, bleaches and bleach activators.

In another aspect of the present invention, there is provided a method of treating dishware, which comprises:

a) washing the dishware with an automatic dishwashing composition; and

b) contacting the dishware, prior to and/or after the dishware washing step, with the booster/rinse aid composition described above.

In another aspect of the present invention, there is provided a kit for treating dishware, which comprises: (a) the booster/rinse aid composition described above, and (b) instructions for directing the use of the composition to treat dishware prior to or after treatment of the dishware with an automatic dishwashing composition.

### DETAILED DESCRIPTION OF THE INVENTION

The present invention is directed to an enzyme-containing booster/rinse aid composition for treatment of dishware prior to or after treatment with an automatic dishwashing composition in an automatic dishwashing machine and method of using the same. The booster/rinse aid composition of the present invention generally comprises enzymes suitable for breaking down protein- and starch-based food deposits, and is specifically formulated for use as a booster in a prewash cycle or as a rinse aid in a rinse cycle of a standard automatic dishwashing machine. The booster/rinse aid composition of the present invention is utilized to improve the cleaning of the automatic dishwashing composition (i.e., enhancing both food residue and deposit removal performance and elimination of spotting and filming on dishware) in a cost efficient manner. The booster/rinse aid composition of the present invention also allows the consumer to vary or customize the amount of enzymes used based on degree of soiling and/or load size. The present invention offers the consumer greater flexibility and cost savings by minimizing waste.

The term “dishware” as used herein refers to any substrate or article, including, but not limited to, glassware, bowls, dishes, dinner plates, drinking cups, containers, pots and pans, cooking and eating utensils, and any food/drink handling articles that typically require treatment in an automatic dishwashing machine to remove any food residues deposited thereon.

The terms “treating” and “treatment” as used herein refer to any process including, but not limited to, cleaning, washing, rinsing, stain removing, coating, sanitizing, rinsing, and the like, that involves contacting a surface of a dishware with a corresponding treating material (e.g., booster, rinse aid), which may be in a dissolved or diluted form, to achieve the desired outcome.

The term “automatic dishwashing machine” as used herein refers to any apparatus or device configured for treating dishware in a manner which results in cleaning, washing, sanitizing, and rinsing of the dishware. Such automatic dishwashing machines typically operate in three or more cycles: a pre-wash cycle, a main wash cycle and one or more rinse cycles. In one typical example, the pre-wash cycle, when used, is typically a cold water cycle lasting from about 5 to 10 minutes. In the main wash cycle, the water comes in cold and is heated from about 55° C. to 75° C., the cycle lasting for about 20 minutes. Rinsing usually comprises two or more separate cycles following the main wash cycle, the first being cold and lasting from about 2 to 5 minutes, the second one starting cold then heating the water from about 65° C. to 75° C. and lasting for about 20 minutes. The automatic dishwashing machine is filled with cold water at the start of each cycle and emptied at the end of each cycle through a filter.

The terms “automatic dishwashing composition” or “ADWC” as used herein refers to any composition formulated with or without enzymes for treating dishware during a main wash cycle in automatic dishwashing machines. The automatic dishwashing composition may be in the form of gels, powders, liquids, tablets, granules, unit dose packs, and the like. Most of the components or ingredients of an automatic dishwashing composition are formulated to work more efficiently during the main wash cycle, due to the temperature and duration of the main wash cycle. The automatic dishwashing composition for the main wash cycle is placed into the main wash dispenser which is automatically opened at the start of the main wash cycle. Some dispensers include apertures which allow water ingress prior to releasing the automatic dishwashing composition during the main wash cycle.

The term “booster” as used herein is intended to refer to the specific use or application of the present composition for the treatment of dishware undergoing the process of food residue and deposit removal prior to the main wash cycle of the automatic dishwashing machine, such as, for example, during a pre-wash cycle portion of the food residue and deposit removal process.

The term “rinse aid” as used herein is intended to refer to the specific use or application of the present composition for the treatment of dishware undergoing the process of food residue and deposit removal after the main wash cycle of the automatic dishwashing machine, such as, for example, during a rinse cycle portion of the food residue and deposit removal process.

As previously indicated, recent changes due at least in part to environmental concerns have led to replacement of phosphates with less efficacious substitutes in automatic dishwashing compositions formulated for automatic dishwashing machines. Such changes have introduced phosphate-free compositions that exhibit reduced cleaning performance. The booster/rinse aid composition of the present invention has been found to be especially useful in improving the performance of such phosphate-free automatic dishwashing compositions by providing an environment for enzymes to perform soil and stain removal in the absence of components that adversely affect their potency. The present booster/rinse aid compositions greatly enhance cleaning and prevention of spotting and filming, while providing customized washing in a cost efficient manner.

The booster/rinse aid composition of the present invention includes enzymes present in effective amounts and in an environment desirable for removing protein- and starch-based food deposits from the surface of dishware prior to or after washing with an automatic dishwashing composition during a main wash cycle in an automatic dishwashing machine. It has been determined that enzymes applied prior to or after washing dishware with the automatic dishwashing composition achieve optimal enzymatic activity rather than when they are applied with the automatic dishwashing composition during the main wash cycle due at least in part to the presence of materials (e.g., alkaline builders, bleaches and bleach activators) which adversely affect the performance of the enzymes.

During the main wash cycle, it is believed that the components in automatic dishwashing compositions such as alkaline builders, bleaches and bleach activators adversely affect the cleaning performance of the enzymes. In this manner, exposing the food deposits and residues to the enzymes during prewash and/or rinse cycles (i.e., non-main wash cycles), in the absence of alkaline builders, bleach, and/or bleach activators, promotes optimal enzymatic activity and food deposit removal. The treatment of the dishware with enzymes prior to or after the main wash cycle also effectively reduces spotting due to the enhanced removal of protein- and starch-based food deposits and residues, which would otherwise provide undesirable nucleation sites for hard water spots.

This permits the consumer to more precisely customize the dishwashing treatment in automatic dishwashing machines by forgoing the use of a more expensive automatic dishwashing composition containing enzymes especially for lightly- to moderately-soiled loads or less than full capacity loads. The consumer has the option to use the present compositions in the pre-wash cycle, the rinse cycle or the combination of the two non-main wash cycles as needed depending on the dishwashing load size and its degree of soiling. For heavily-soiled and full capacity loads, the consumer can selectively use enzyme-containing automatic dishwashing compositions on those occasions as needed to maximize cleaning efficacy. By offering the consumer the means to customize the dishwashing treatment in this manner, the consumer will minimize waste and realize cost savings, while at least maintaining or enhancing cleaning efficacy for a particular dishwashing load.

In one embodiment of the present invention, there is provided a booster/rinse aid composition (referred hereinafter simply as a “composition”) formulated for treatment of dishware prior to and/or after treatment with an automatic dishwashing composition, which comprises at least one surfactant, at least one anionic polymer, and at least one enzyme, wherein the composition is at least substantially free of alkaline builders, bleaches and bleach activators. The present composition is intended for use in automatic dishwashing machines as a booster during pre-wash or pre-rinse cycles, as a rinse aid during rinse cycles or as a combination of both, for a given dishwashing load.

The composition includes at least one surfactant in any effective amount or form. The surfactant component is present in an amount effective for reducing the surface tension of water, emulsifying oil, lipid and fat of food deposits, and/or for preventing spotting when drying. The surfactant component of the present composition may be, for example, selected from suitable surface active compounds which are commercially available and described in the literature, e.g., in “Surface Active Agents and Detergents,” Volumes 1 and 2 by Schwartz, Perry and Berch. The surfactant component is selected from nonionic surfactants, preferably low foaming nonionic surfactants. Suitable nonionic surfactants include, for example, alkoxylated alcohols such as 2-ethyl hexyl alkoxylate.

The surfactant may generally be present in an amount of at least 0.1 wt % based on the total weight of the composition, preferably from about 0.1 wt % to 30.0 wt %, more preferably from about 5 wt % to 20 wt %, and most preferably about 10 wt %.

The composition of the present invention further includes at least one anionic polymer. Suitable anionic polymers include, for example, polyacrylic acid. The preferred polyacrylic acid component has a molecular weight of from about 100 and 10,000, preferably from about 500 to 5,000. An especially preferred molecular weight range is from about 1,000 to 3,000. The anionic polymer is preferably provided in amounts of from about 0.05 wt % to 10.00 wt % based on the total weight of the composition, preferably from about 0.1 wt % to 5.0 wt %, and more preferably from about 1 wt % to 5 wt %.

The composition of the present invention further includes at least one enzyme selected from food compatible, soil and/or stain removing enzymes such as amylases, lipases, proteases, cellulases and combinations thereof. Any suitable species of these enzymes may be used. The enzyme is present in an amount effective for removing food residues and deposits from the surface of dishware. The enzyme may be present in amounts of from about 0.01 wt % to 20.00 wt % based on the total weight of the composition, preferably from about 0.1 wt % to 16.0 wt %, and more preferably from about 0.1 wt % to 10.0 wt %.

The preferred enzyme is selected from amylases, proteases and combinations thereof. The amylase enzyme component may be formulated in amounts of from about 0.1 wt % to 6.0 wt % based on the total weight of the composition, and preferably from about 2 wt % to 4 wt %. The protease enzyme component may be formulated in amounts of from about 0.1 wt % to 10.0 wt % based on the total weight of the composition, and preferably from about 4 wt % to 6 wt %.

The composition of the present invention may further include one or more chelating agents in amounts sufficient to inhibit crystal growth or formation of crystals. Such chelating agents are capable of solubilizing mineral deposits including calcium carbonate, for example. In particular, the chelating agents form bonds with metal ions to form soluble complex molecules, thus inactivating such ions from reacting with other elements or ions to produce precipitates or scale. The complex molecules remain suspended and thus easily rinse away and do not form a deposit.

A suitable chelating agent is, for example, L-glutamic acid N,N-diacetic acid tetrasodium salt. It is understood that other known chelating agents such as, for example, those listed in the Kirk-Othmer Encyclopedia of Chemical Technology, Volume 5, 4th Ed. (1993), can also be used in the present invention. The chelating agents may be easily tested for suitability through routine methods by those skilled in the art in accordance with the present invention. The chelating agent may be present in specific amounts of up to 15 wt % based on the total weight of the composition, preferably up to 10 wt %, and more preferably from about 0.01 wt % to 8.00 wt %.

The compositions may contain other optional ingredients, including, but not limited to, enzyme stabilizers, dyes, rheology modifiers, foam control agents, surface modification agents, neutralizing agents and combinations thereof. These optional ingredients may be included at any desired level. The balance of the present composition is water.

The present composition may be formulated into any suitable product form as desired. Suitable product forms include, but are not limited to, liquids, anhydrous liquids, gels, pastes, semi-solids, and combinations thereof.

In another embodiment of the present invention, there is provided a method of treating dishware in need of removal of food deposits and residues. The present method includes washing the dishware with an automatic dishwashing composition, and prior to and/or after the dishware washing step, contacting the surface of the dishware with the composition of the present invention. An effective amount of the composition of the present invention may be applied directly onto dishware surfaces. When the composition of the present invention is applied onto a dishware surface, an effective amount of the enzymes is deposited onto the dishware surface, with the dishware surface becoming damp or totally saturated with the composition.

The composition can be applied to a dishware surface via roll coating, curtain coating, dipping and/or soaking, spraying, immersing, splashing, and other suitable means of application. Any of the application steps can subsequently be followed by a drying step, curing step, and/or washing step using an automatic dishwashing composition.

In particular, the composition of the present invention is preferably dispensed into the interior of an automatic dishwashing machine during the performance of a dishwashing program, prior to the start of the main washing cycle or after the course of the main washing cycle is completed. Dispensing or introduction of the present composition according to the invention into the interior of the automatic dishwashing machine may proceed manually, but the present composition is preferably dispensed into the interior of the dishwashing machine by means of the dispensing chamber of the automatic dishwashing machine.

The compositions of the present invention can be used to treat all dishware surfaces to provide at least one of the following benefits including wetting and sheeting, uniform drying, anti-staining, anti-spotting, anti-filming, food deposit and residue removal, and the like.

In another embodiment of the present invention, there is provided a booster/rinse aid composition for treatment of dishware prior to or after treatment with an automatic dishwashing composition, consisting essentially of at least one surfactant, at least one anionic polymer, and at least one enzyme, wherein the present composition is at least substantially free of alkaline builders, bleaches and bleach activators.

In another embodiment of the present invention, there is provided a kit for treating dishware, comprising (a) the composition of the present invention, and (b) instructions which instruct the consumer to use the present composition to treat dishware prior to or after treatment of the dishware with an automatic dishwashing composition. The instructions may instruct the consumer on the use of the present composition to treat dishware surfaces by contacting a dishware surface in need of treatment with an effective amount of the composition such that the present composition imparts one or more desired surface coating benefits to the dishware surface.

The kit may further include the automatic dishwashing composition, which may be phosphate-free and may further comprise at least one enzyme. The kit of the present invention allows the consumer to implement the steps of the present invention as described above. The instructions are generally provided in any suitable manner typically packaged in consumer products. The instructions may be, for example, printed on a label attached to a packaging holding the composition, and optionally the automatic dishwashing composition, if included, or on a sheet attached to the packaging or accompanying it when purchased.

In a particular embodiment of the present invention, the instructions may include description on the use of the composition, including, for example, the advised amount to apply or dispense to the surface of the dishware, the specific cycles during which the present composition is dispensed prior to or after the main wash cycles, its use in combination with an automatic dishwashing composition with or without enzymes, and the like.

### EXAMPLES

### Example 1

### A Formulation of a Composition of the Present Invention

An illustrative example of the composition of the present invention is provided with various components listed in Table 1 below.

TABLE 1
Illustrative Formulation of Present Composition

| Component | Amount (wt %) |
|---|---|
| 2-ethylhexyl alkoxylate (surfactant) | 10 |
| Polyacrylic acid (2K MW) | 2.5 |
| L-glutamic acid N,N-diacetic acid tetrasodium salt | 2.5 |
| Protease | 5 |
| Amylase | 3 |
| Carrier and Optional Ingredients (Enzyme | QS |
| stabilizers, dyes, etc.) | |

### Example 2

### A Kit for Treating Dishware

The composition of Example 1 may be sold in a package as a kit for the consumer to implement the present invention. Since the present composition is formulated for use in an automatic dishwashing machine, it may be beneficial to provide instructions to the consumer for using the composition. The usage instructions can be provided to the consumer by any means known in the art such as by text, pictures, graphics, diagrams, drawings or illustrations printed on the packaging or container.

As an example, the instructions can include the following steps.

1) Estimate the level of food soil and size of a particular dishwashing load.

2) Place dishware of the dishwashing load into the automatic dishwashing machine.

3) Select a schedule of cleaning cycles for execution by the automatic dishwashing machine on the particular dishwashing load based on the soil level and load size.

4) Fill the booster/rinse composition in the corresponding dispensers set for release prior to or after the main wash cycle.

5) Fill the dispenser with an automatic dishwashing composition, which may optionally contain enzymes, set for release during the main wash cycle.

6) Initiate operation of the automatic dishwashing machine.

### Example 3

### Testing of Soil Removal Using the Composition of the Present Invention

A series of treatments were completed on soiled tiles to evaluate the performance of the present composition when used as a booster and when used as a rinse aid. All the treatments were conducted using commercially available consumer automatic dishwashing machines. As shown in Table 2 below, the first three treatments (Treatments 1-3) were tested using a pre-wash cycle, a normal main wash cycle, and a rinse cycle. The remaining treatments (Treatments 4-9) were tested using a normal main wash cycle and a rinse cycle, excluding the pre-wash cycle. Water hardness was maintained at 300 ppm and 50-g of IKW ballast soil was added to each treatment.

TABLE 2
Test Treatments

| | | Treatment Components | | | | |
|---|---|---|---|---|---|---|
| | | | | Rinse | | |
| | | Booster | Detergent | Aid | | |
| Treatment | | (g) | (g) | (g) | Protease | Amylase |
| 1 | Non-Enzymatic | — | 45 | — | — | — |
| | Detergent | | | | | |
| | (control) | | | | | |
| 2 | Non-Enzymatic | 15 | 45 | — | — | — |
| | Detergent + | | | | | |
| | Booster without | | | | | |
| | Enzyme | | | | | |
| 3 | Non-Enzymatic | 15 | 45 | — | 0.4 | 0.2 |
| | Detergent + | | | | | |
| | Booster with | | | | | |
| | Enzyme | | | | | |
| 4 | Non-Enzymatic | — | 45 | — | — | — |
| | Detergent | | | | | |
| | (control) | | | | | |
| 5 | Non-Enzymatic | — | 45 | 3 | — | — |
| | Detergent + | | | | | |
| | Rinse Aid | | | | | |
| | without Enzyme | | | | | |
| 6 | Non-Enzymatic | — | 45 | 3 | 0.4 | 0.2 |
| | Detergent + | | | | | |
| | Rinse Aid | | | | | |
| | with Enzyme | | | | | |
| 7 | Non-Enzymatic | — | 45 | 3 | — | — |
| | Detergent + | | | | | |
| | Competitive | | | | | |
| | Rinse Aid | | | | | |
| 8 | Enzymatic | — | 1 Tab | — | — | — |
| | Detergent Only | | | | | |
| 9 | Enzymatic | — | 1 Tab | 3 | 0.4 | 0.2 |
| | Detergent + | | | | | |
| | Rinse Aid | | | | | |
| | with Enzyme | | | | | |

The formulation used in Treatments 2 and 5 as booster and rinse aid without enzyme, respectively, is shown with various components listed in Table 3 below.

TABLE 3
Formulation of Booster/Rinse Aid Absent Enzymes

| Component | wt, % (as is) | wt, g | Actual, g |
|---|---|---|---|
| Water | 75.37 | 979.78 | 979.81 |
| sodium citrate | 10.00 | 130.00 | 130.05 |
| 2-ethylhexyl-EO-PO | 5.00 | 65.00 | 68.75 |
| polyacrylic acid, 2k | 5.00 | 65.00 | 65.02 |
| sodium formate | 1.50 | 19.50 | 19.55 |
| propylene glycol | 3.00 | 39.00 | 39.15 |
| calcium chloride dihydrate | 0.13 | 1.72 | 1.72 |
| pH adjust w/NaOH (50% sol.) | | | 21.97 |
| Protease | 0.00 | 0.00 | — |
| Amylase | 0.00 | 0.00 | — |
| Total | 100.00 | 1300.00 | |

The results of the test are shown below in Table 4 below. The values listed represent “% soil removal.”

TABLE 4
Treatment Results for Each Soil Type

| | | Treatment of Food Deposit Results | | | | | |
|---|---|---|---|---|---|---|---|
| | | | | DM92 Double | | | |
| | | DM21 Egg | DM31 Egg | Soiled Minced | DM76 Corn | DM77 Mix | DM78 Rice |
| Treatment | | Yolk | Yolk + Milk | Meat | Starch | Starch | Starch |
| 1 | Non-Enzymatic Detergent | 4.6 | −2.8 | 13.6 | 15.9 | 15.6 | 15.4 |
| | (control) | | | | | | |
| 2 | Non-Enzymatic Detergent + | 8.3 | −2.3 | 15.5 | 16.9 | 16.9 | 15.9 |
| | Booster | | | | | | |
| 3 | Non-Enzymatic Detergent + | 12 | −1.2 | 15.1 | 31.5 | 31.5 | 38.2 |
| | Booster with Enzyme | | | | | | |
| 4 | Non-Enzymatic Detergent | 4.7 | −1.6 | 17.5 | 17.3 | 16.9 | 16.7 |
| | (control) | | | | | | |
| 5 | Non-Enzymatic Detergent + | 1.5 | −7.5 | 11.7 | 17.4 | 16.6 | 16.6 |
| | Rinse Aid | | | | | | |
| 6 | Non-Enzymatic Detergent + | 21.9 | 8.3 | 40.9 | 83.5 | 82.1 | 78.7 |
| | Rinse Aid with Enzyme | | | | | | |
| 7 | Non-Enzymatic Detergent + | 4.6 | −0.5 | 20.3 | 19.6 | 17 | 16.5 |
| | Competitive Rinse Aid | | | | | | |
| 8 | Enzymatic Detergent Only | 35.3 | 24.7 | 50.8 | 50.1 | 44.2 | 30.9 |
| 9 | Enzymatic Detergent + | 40.6 | 33.6 | 68.5 | 85.1 | 80.4 | 79.1 |
| | Rinse Aid with Enzyme | | | | | | |

| | | | | | | |
|---|---|---|---|---|---|---|
| HSD(0.95) | 9.6 | 6.8 | 2.5 | 2 | 2.6 | 3 |

For each of the treatments, the removal of six soils was measured. These include egg yolk, egg yolk+milk, double soiled minced meat, corn starch, mixed starch, and rice starch. These are industry accepted control soils provided by an independent third party. Data presented indicate percent soil removal, measured instrumentally. The HSD (0.95) indicates the smallest soil removal difference necessary to conclude that data points are significantly different.

As can be seen from the data below in Table 4, the present composition significantly improves performance against key soils when used as a rinse aid or a booster (see Treatments 3, 6 and 9) as compared to the treatments using boosters and rinse aids with no enzymes. The improved performance using the present composition was observed whether using an enzymatic or non-enzymatic ADWC.

Comparing the data of Treatments 1-3, it was observed that using the composition of the present invention as a booster improves the performance against all three starch soils as compared to no booster or booster without enzymes.

The data of Treatments 4-7 indicate improvement in food residue and deposit removal when using the present composition as a rinse aid as compared to no rinse aid or rinse aid without enzymes. This improvement was observed on all soils tested. Conversely, the non-enzymatic rinse aid (Treatment 5) and the competitive rinse aid (Treatment 7) showed no improvement versus the non-enzymatic detergent alone (Treatment 4).

The data of the final Treatments 8 and 9 demonstrate that the composition of the present invention functions well as a rinse aid when used with a non-enzymatic detergent as well as an enzymatic detergent.

### Example 4

Visual Grading of Film Properties Comparing Performance of the Compositions of the Present Invention

Using a select group of trained judges (A-F), an evaluation of visual ratings of drinking glasses comparing the performance of the present compositions was performed. As shown in Table 5 below, the evaluation was implemented under specific conditions: detergent alone (D), detergent plus non-enzymatic rinse aid (D+RA) and detergent plus rinse aid with enzymes (D+RA(E)) over a five wash trial. A conventional automatic dishwashing machine was used on the Water Miser cycle (to eliminate the pre-wash step). The water hardness was constant at 300 ppm and 50-g of IKA ballast soil was added in addition to additional egg yolk and starch solution to further stress the system.

The data presented in Table 5 represent visual evaluations made by the trained judges. The judges assessed filming and spotting on the glassware. Each row shows one comparison (left vs. right), the judge's preference (left, right or no preference; L, R or N), and the relative difference (slightly different, none, or significant). The data indicates that when the present compositions used as rinse aids were compared to those without enzymes, the glasses that were treated with enzymes were consistently and significantly rated as being cleaner.

TABLE 5
Results on Visual Grading of Film Properties

| | | | Judge's Preference | | | | | | | | | | | |
|---|---|---|---|---|---|---|---|---|---|---|---|---|---|---|
| | Glass Position* | | (Cleaner Looking) | | | | | | Judge's Cleaning Difference Rating | | | | | |
| Row | Left | Right | A | B | C | D | E | F | A | B | C | D | E | F |
| 1 | D | D | L | N | N | N | L | N | Slight | None | None | None | Slight | None |
| 2 | D + RA | D + RA | R | N | R | N | N | N | Slight | None | Slight | None | None | None |
| 3 | D + RA(E) | D + RA(E) | R | N | N | R | N | R | Slight | None | None | Slight | None | Slight |
| 4 | D | D + RA | L | R | R | R | R | N | Slight | Slight | Slight | Slight | Slight | Slight |
| 5 | D | D + RA | R | N | N | N | N | N | Slight | None | None | None | None | None |
| 6 | D + RA | D | L | L | L | L | L | L | Slight | Slight | Slight | Slight | Slight | Slight |
| 7 | D + RA | D | L | R | N | N | N | L | Slight | Slight | None | None | None | Slight |
| 8 | D + RA(E) | D + RA | L | L | L | L | L | L | Slight | Significant | Significant | Significant | Slight | Significant |
| 9 | D + RA | D + RA(E) | R | R | R | R | R | R | Significant | Significant | Significant | Significant | Significant | Significant |
| 10 | D + RA | D + RA(E) | R | R | R | R | R | R | Significant | Significant | Significant | Significant | Slight | Significant |
| 11 | D + RA(E) | D + RA | L | L | L | L | L | L | Significant | Significant | Significant | Significant | Significant | Significant |
| 12 | D + RA(E) | D | L | L | L | L | L | L | Significant | Significant | Significant | Significant | Significant | Significant |
| 13 | D | D + RA(E) | R | R | R | R | R | R | Significant | Significant | Significant | Significant | Significant | Significant |
| 14 | D | D + RA(E) | R | R | R | R | R | R | Significant | Significant | Significant | Significant | Significant | Significant |
| 15 | D + RA(E) | D | L | L | L | L | L | L | Significant | Significant | Significant | Significant | Significant | Significant |

*D = Detergent; RA = Rinse Aid; E = Enzyme

The data for Rows 1-3 demonstrate that the judges did not see a significant difference between glasses when glasses from the same treatment are compared with one another. For example, Row 1 indicated that there was no consistent preference between glasses which were both washed with detergent alone. The data for Rows 4-7 show the comparison of detergent alone vs. detergent plus rinse aid. Again, the judges did not perceive any significant difference between the treatments. The data for Rows 8-12 demonstrate a clear preference for the present composition used as a rinse aid as compared to the treatments using the non-enzymatic rinse aid. When detergent alone is compared to detergent plus the present composition used as a rinse aid, as shown in the data for Rows 13-15, the preference again was for the detergent plus the present composition used as a rinse aid.

The foregoing discussion discloses and describes merely exemplary embodiments of the present invention. One skilled in the art will readily recognize from such discussion, and from the accompanying drawings and claims, that various changes, modifications and variations can be made therein without departing from the spirit and scope of the invention as defined in the following claims.

What is claimed is:

1. A booster/rinse aid composition for treatment of dishware prior to or after treatment with an automatic dishwashing composition, comprising:
at least one surfactant;
at least one anionic polymer; and
at least one enzyme;
wherein said composition is at least substantially free of alkaline builders, bleaches and bleach activators.

2. The composition of claim 1 wherein:
said surfactant is present in amounts of at least 0.1 wt % based on the total weight of the composition;
said one anionic polymer is present in amounts of from about 0.05 wt % to 10.00 wt % based on the total weight of the composition; and
said enzyme is present in amounts of from about 0.01 wt % to 20.00 wt % based on the total weight of the composition.

3. The composition of claim 2 wherein:
said surfactant is present in amounts of from about 0.1 wt % to 30.0 wt %;
said one anionic polymer is present in amounts of from about 0.1 wt % to 5.0 wt %; and
said enzyme is present in amounts of from about 0.1 wt % to 16.0 wt %.

4. The composition of claim 1 wherein the at least one enzyme is selected from the group consisting of protease, amylase, and combinations thereof.

5. The composition of claim 4 wherein the amount of protease is from about 0.1 wt % to 10.0 wt % based on the total weight of the composition.

6. The composition of claim 4 wherein the amount of amylase is from about 0.1 wt % to 6.0 wt % based on the total weight of the composition.

7. The composition of claim 1 wherein the surfactant is a nonionic surfactant.

8. The composition of claim 1 wherein the amount of the surfactant is from about 0.1 wt % to 30.0 wt % based on the total weight of the composition.

9. The composition of claim 1 wherein the at least one anionic polymer is polyacrylic acid.

10. The composition of claim 1 wherein the amount of said at least one anionic polymer is from about 0.1 wt % to 5.0 wt % based on the total weight of the composition.

11. The composition of claim 1 further comprising a chelating agent.

12. The composition of claim 11 wherein the chelating agent is present in an amount of up to about 15 wt % based on the total weight of the composition.

13. A booster/rinse aid composition for treatment of dishware prior to or after treatment with an automatic dishwashing composition, consisting essentially of:
at least one surfactant;
at least one anionic polymer; and
at least one enzyme;
wherein said composition is at least substantially free of alkaline builders, bleaches and bleach activators.

14. A method of treating dishware, comprising:
a) washing said dishware with an automatic dishwashing composition; and
b) contacting the dishware, prior to and/or after the washing step, with the booster/rinse aid composition of claim 1.

15. A kit for treating dishware, comprising:
(a) the composition of claim 1, and
(b) instructions for directing the use of said composition to treat dishware prior to or after treatment of the dishware with an automatic dishwashing composition.

16. The kit of claim 15 wherein:
said surfactant is present in amounts of at least 0.1 wt % based on the total weight of the composition;
said one anionic polymer is present in amounts of from about 0.05 wt % to 10.00 wt % based on the total weight of the composition; and
said enzyme is present in amounts of from about 0.01 wt % to 20.00 wt % based on the total weight of the composition.

17. The kit of claim 16 wherein:
said surfactant is present in amounts of from about 0.1 wt % to 30.0 wt %;
said one anionic polymer is present in amounts of from about 0.1 wt % to 5.0 wt %; and
said enzyme is present in amounts of from about 0.1 wt % to 16.0 wt %.

18. The kit of claim 15 further comprising said automatic dishwashing composition.

19. The kit of claim 18 wherein said automatic dishwashing composition is phosphate-free.

20. The kit of claim 15 wherein said automatic dishwashing composition comprises at least one enzyme.
